(19) United States
(12) Patent Application Publication
(10) Pub. No.: US 2023/0406114 A1
(43) Pub. Date: Dec. 21, 2023

(54) A METHOD FOR A PROCEDURE OF CONNECTION AND DISCONNECTION OF A VEHICLE TO/FROM A PLURALITY OF ELECTRICAL LINES

(71) Applicant: Scania CV AB, Södertälje (SE)

(72) Inventor: Christer THORÉN, Huddinge (SE)

(73) Assignee: Scania CV AB, Södertälje (SE)

(21) Appl. No.: 18/032,228

(22) PCT Filed: Oct. 25, 2021
(86) PCT No.: PCT/SE2021/051072

§ 371 Date: Apr. 17, 2023

(30) Foreign Application Priority Data
Nov. 5, 2020 (SE) 2051287-7

(51) Int. Cl. B60L 9/18; B60L 3/00; B60L 3/04; B60L 5/24

(52) U.S. Cl. CPC B60L 9/18; B60L 3/0023; B60L 3/04; B60L 5/24

(57) ABSTRACT

A method for a procedure of connection and disconnection of a vehicle to/from a plurality of electrical lines of an electric road system, wherein the connection and disconnection procedure comprises in response to a disconnect warning and if the vehicle is connected to the plurality of electrical lines, blocking the electric current from the plurality of electrical lines to a powertrain of the vehicle. The method comprises: maintaining the connection of the vehicle to the plurality of electrical lines while the electric current from the plurality of electrical lines to the powertrain of the vehicle is blocked in response to the disconnect warning. A control arrangement implementing such a method.

### CROSS-REFERENCE TO RELATED APPLICATIONS

This application is a National Stage Patent Application (filed under 35 § U.S.C. 371) of PCT/SE2021/051072, filed Oct. 25, 2021, of the same title, which, in turn claims priority to Swedish Patent Application No. 2051287-7 filed Nov. 5, 2020, of the same title; the contents of each of which are hereby incorporated by reference.

### FIELD OF THE INVENTION

Aspects of the present invention relate to a method for a procedure of connection and disconnection of a vehicle to/from a plurality of electrical lines of an electric road system.

### BACKGROUND OF THE INVENTION

Instead of using its own electric batteries or combustion engine, or any other electrical energy source, for example one or more fuel cells, for providing electric power to the vehicle, for example for the propelling of the vehicle, some vehicles may connect to an electric road system, ERS, which includes a plurality of electrical lines, for example for the provision of DC to the vehicle. The plurality of electrical lines may comprise a plurality of overhead electrical lines, a plurality of ground-level electrical lines, or a plurality of lateral electrical lines, or combinations thereof. When the vehicle is on a proper path on the road associated with the electric road system, ERS, the vehicle may connect and stay connected to the plurality of electrical lines according to certain procedures, and thus save fuel and/or electric power of its own electrical energy sources.

### SUMMARY OF THE INVENTION

The inventors of the present invention have found drawbacks in conventional solutions for the connection and/or disconnection of a vehicle to/from a plurality of electrical lines of an electric road system, ERS. For example, some conventional solutions provide an inefficient connection and disconnection procedure with regard to the plurality of electrical lines of the electric road system, ERS, which results in an inefficient use of the electric road system, ERS, and therefore results in a higher consumption of fuel and/or power from electrical energy sources, such as electric batteries, carried by the vehicle.

An object of the invention is to provide a solution which mitigates or solves the drawbacks and problems of conventional solutions.

The above and further objects are solved by the subject matter of the independent claims. Further advantageous embodiments of the invention can be found in the dependent claims.

According to a first aspect of the invention, the above mentioned and other objects are achieved with a method for a procedure of connection and disconnection of a vehicle to/from a plurality of electrical lines of an electric road system, wherein the connection and disconnection procedure comprises:
a. in response to a disconnect warning and if the vehicle is connected to the plurality of electrical lines (for example, if the vehicle is in a connected state in relation to the plurality of electrical lines), blocking the electric current from the plurality of electrical lines to a powertrain of the vehicle,
b. wherein the method comprises:
c. maintaining the connection of the vehicle to the plurality of electrical lines while the electric current from the plurality of electrical lines to the powertrain of the vehicle is blocked in response to the disconnect warning.

It is to be understood that the connection of the vehicle to the plurality of electrical lines of the electric road system, ERS, according to the connection and disconnection procedure is both mechanical and electrical, i.e. both a mechanical connection and an electrical connection are provided between the vehicle and the plurality of electrical lines. It is to be understood that the disconnection of the vehicle from the plurality of electrical lines of the electric road system, ERS, according to the connection and disconnection procedure is both mechanical and electrical, i.e. both an electrical disconnection and a mechanical disconnection of the vehicle from the plurality of electrical lines are performed or executed. Thus, since the connection (i.e. both the mechanical and electrical connections) of the vehicle to the plurality of electrical lines is maintained according to the method according to the first aspect and its embodiments, the electric current from the plurality of electrical lines to the vehicle per se is not blocked. Instead, the electric current from the plurality of electrical lines to the powertrain of the vehicle is blocked according to the method according to the first aspect and its embodiments, while maintaining the connection of the vehicle to the plurality of electrical lines.

It may be defined that the plurality of electrical lines and/or the electric road system, ERS, are/is configured to provide an electric power supply, or electric power, to the vehicle, which is connected to the plurality of electrical lines. It may be defined that the plurality of electrical lines and/or the electric road system, ERS, are/is configured to provide direct current, DC, power to a connected vehicle. It may be defined that the plurality of electrical lines and the electric road system, ERS, are configured for direct current, DC. It may be defined that the plurality of electrical lines comprises or consists of two direct current lines, one for DC+ and the other one for DC−. The plurality of electrical lines and the electric road system, ERS, may be configured for high voltage, such as a voltage above 60 V, for example above 400 V, or above 450 V, such as above 650 V. For example, the plurality of electrical lines and the electric road system, ERS, may be configured for a voltage up to 1500 V and/or for a voltage above 1500 V.

An advantage of the method according to the first aspect is that, since the connection of the vehicle to the plurality of electrical lines is maintained but with the electric current from the plurality of electrical lines to the powertrain of the vehicle blocked, the powertrain of the vehicle can be more quickly electrically reconnected to the electric road system, ERS, for example when the disconnect warning is cleared, or disappears. Thus, an advantage of the method according to the first aspect is that the steps of reconnecting the vehicle to the electric road system, ERS, are less time-consuming, which results in a more efficient use of the electric road system, ERS, i.e. the vehicle stays connected to the electric road system, ERS, for a longer time, and the electric road system, ERS, is used more by vehicles, or expressed alternatively, the time when the vehicle is disconnected from the electric road system, ERS, is reduced. This results in a reduction of the consumption of fuel and/or power from electrical energy sources, such as electric batteries, carried by the vehicle. Thus, the efficiency of the electric road system, ERS, is improved. An advantage of the method according to the first aspect is that the connection and disconnection procedure for the vehicle is improved. An advantage of the method according to the first aspect is that a more efficient connection and disconnection procedure with regard to the plurality of electrical lines is provided, for example involving less time-consuming steps of reconnecting the vehicle to the electric road system, ERS. Since the amount of disconnection of the vehicle from the electric road system, ERS, and consequently the amount of reconnecting the vehicle to the electric road system, ERS, are reduced, the wear on the equipment used for the connection and disconnection of the vehicle is reduced, which results in less maintenance of the equipment for the connection and disconnection of the vehicle, which in turn results in an increased uptime of the vehicle, i.e. the time the vehicle is up and running and actively used, for example driven on the road. The powertrain may include one or more electric motors or machines. It may be defined that the powertrain and/or the one or more electric motors is/are configured to propel, or drive, the vehicle.

According to an advantageous embodiment of the method according to the first aspect, the vehicle comprises or consists of, or is, an electric vehicle,
a. wherein the connection and disconnection procedure comprises the connection and disconnection of the electric vehicle to/from the plurality of electrical lines of an electric road system,
b. wherein the connection and disconnection procedure comprises:
c. in response to the disconnect warning and if the electric vehicle is connected to the plurality of electrical lines, blocking the electric current from the plurality of electrical lines to a powertrain of the electric vehicle,
d. wherein the method comprises:
e. maintaining the connection of the electric vehicle to the plurality of electrical lines while the electric current from the plurality of electrical lines to the powertrain of the electric vehicle is blocked in response to the disconnect warning.

The electric vehicle, EV, may, for example, comprise or consist of a hybrid vehicle or a hybrid electric vehicle, HEV, or a battery electric vehicle, BEV. Thus, a hybrid electric vehicle, HEV, and a battery electric vehicle, BEV, are versions, or examples, of an electric vehicle, EV. Otherwise, the vehicle, or the electric vehicle, EV, may be of a sort disclosed below in connection with the fifth aspect of the invention and/or in the detailed description.

According to a further advantageous embodiment of the method according to the first aspect, the blocking of the electric current from the plurality of electrical lines to the powertrain of the vehicle is performed in the vehicle. Since the plurality of electrical lines and the electric road system, ERS, may be configured to provide electric power to two or more vehicles at the same time, the blocking of the electric current from the plurality of electrical lines to the powertrain of the vehicle in the vehicle is advantageous. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system, ERS. Embodiments with more specified locations of the blocking of the electric current from the plurality of electrical lines to the powertrain in the vehicle are disclosed hereinbelow.

According to another advantageous embodiment of the method according to the first aspect, the blocking of the electric current from the plurality of electrical lines to the powertrain of the vehicle comprises decreasing the electric current from the plurality of electrical lines to the powertrain of the vehicle below a first threshold. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system, ERS. It may be defined that said decrease of the electric current from the plurality of electrical lines to the powertrain of the vehicle below the first threshold is performed in the vehicle.

According to yet another advantageous embodiment of the method according to the first aspect, the blocking of the electric current from the plurality of electrical lines to the powertrain of the vehicle comprises decreasing the electric current from the plurality of electrical lines to the powertrain of the vehicle to zero. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system, ERS. It may be defined that said decrease of the electric current from the plurality of electrical lines to the powertrain of the vehicle to zero is performed in the vehicle.

According to still another advantageous embodiment of the method according to the first aspect, the method comprises:
a. when the connection of the vehicle to the plurality of electrical lines is maintained and the disconnect warning is cleared, passing the electric current from the plurality of electrical lines to the powertrain of the vehicle.

An advantage of this embodiment is that the powertrain of the vehicle can be more quickly electrically reconnected to the electric road system, ERS, when the disconnect warning is cleared, or disappears. Thus, an advantage of this embodiment is that the steps of reconnecting the vehicle to the electric road system, ERS, are less time-consuming, which is results in a more efficient use of the electric road system, ERS, i.e. the vehicle stays connected to the electric road system, ERS, for a longer time, and the electric road system, ERS, is used more by vehicles. An advantage of this embodiment is that the connection and disconnection procedure for the vehicle is improved.

According to an advantageous embodiment of the method according to the first aspect, the passing of the electric current from the plurality of electrical lines to the powertrain of the vehicle is performed in the vehicle. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system ERS.

According to another advantageous embodiment of the method according to the first aspect, the passing of the electric current from the plurality of electrical lines to the powertrain of the vehicle comprises increasing the electric current from the plurality of electrical lines to the powertrain of the vehicle above a second threshold. An advantage of this embodiment is that the powertrain of the vehicle can be more quickly electrically reconnected to the electric road system, ERS, when the disconnect warning is cleared, or disappears. Thus, an advantage of this embodiment is that the step of reconnecting the vehicle to the electric road system, ERS, is less time-consuming, which is results in a more efficient use of the electric road system, ERS, i.e. the vehicle stays connected to the electric road system, ERS, for a longer time, and the electric road system, ERS, is used more by vehicles. An advantage of this embodiment is that the connection and disconnection procedure for the vehicle is improved.

According to a further advantageous embodiment of the method according to the first aspect, the increase of the electric current from the plurality of electrical lines to the powertrain of the vehicle is performed in the vehicle. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system ERS.

According to another advantageous embodiment of the method according to the first aspect, the method comprises:
a. when the connection of the vehicle to the plurality of electrical lines is maintained and the disconnect warning is not cleared, disconnecting the vehicle from the plurality of electrical lines while the electric current from the plurality of electrical lines to the powertrain of the vehicle is blocked in response to the disconnect warning. The step of disconnecting the vehicle from the plurality of electrical lines may be performed after the expiry of a time period triggered by the issuance of the disconnect warning and if the disconnect warning is not cleared within said time period.

According to still another advantageous embodiment of the method according to the first aspect, the disconnect warning comprises one or more of the group of:
a. the vehicle is about to leave a proper path of a road associated with the electric road system;
b. a voltage associated with the electric current from the plurality of electrical lines to the powertrain of the vehicle falls below a third threshold;
c. the vehicle is about to leave a first predefined zone associated with the electric road system; and
d. the vehicle is about to enter a second predefined zone associated with the electric road system.

An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system, ERS. Other disconnect warnings are also possible. The proper path may be defined and/or monitored by a lane keep/keeping assist/assistance, LKA, system and/or a lane departure warning system, LDWS, and/or a global positioning system, GPS. The first and/or second predefined zones may be defined and/or monitored by a global positioning system, GPS.

According to yet another advantageous embodiment of the method according to the first aspect, the vehicle comprises an interface for providing connection between the vehicle and the plurality of electrical lines, and
a. wherein the interface comprises a connection device movable between a connection position, in which the connection device and the vehicle are connected to the plurality of electrical lines, and a disconnection position, in which the connection device and the vehicle are disconnected from the plurality of electrical lines,
b. wherein the step of maintaining the connection of the vehicle to the plurality of electrical lines, while the electric current from the plurality of electrical lines to the powertrain of the vehicle is blocked in response to the disconnect warning, comprises maintaining the connection device in the connection position.

Since the amount of disconnection of the vehicle from the electric road system, ERS, and consequently the amount of reconnection of the vehicle to the electric road system, ERS, are reduced, the wear on the connection device of the interface is reduced, resulting in less maintenance of the connection device, which in turn results in an increased uptime of the vehicle, i.e. the time the vehicle is up and running and actively used, for example driven on the road. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system, ERS. The connection device may, for example, comprise a mechanical linkage and/or a foldable configuration, for example a pantograph, or any other suitable configuration movable in relation to a chassis of the vehicle, such as a telescopic configuration.

According to an advantageous embodiment of the method according to the first aspect, the step of disconnecting the vehicle from the plurality of electrical lines, while the electric current from the plurality of electrical lines to the powertrain of the vehicle is blocked in response to the disconnect warning, comprises moving the connection device from the connection position to the disconnection position.

According to a further advantageous embodiment of the method according to the first aspect, the vehicle comprises an interface for providing connection between the vehicle and the plurality of electrical lines, and
a. wherein the interface comprises a DC-to-DC converter,
b. wherein the method comprises controlling the DC-to-DC converter to block and/or pass the electric current from the plurality of electrical lines to the powertrain of the vehicle.

An advantage of this embodiment is that an efficient blocking of the electric current from the plurality of electrical lines to the powertrain of the vehicle is provided without disconnecting the vehicle from the plurality of electrical lines. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system, ERS.

According to another advantageous embodiment of the method according to the first aspect, the vehicle comprises an interface for providing connection between the vehicle and the plurality of electrical lines,
a. wherein the interface comprises an electrically operable switching device switchable between an open position and a closed position,
b. wherein when the switching device is in the closed position the switching device is configured to allow the electric current to pass, and
c. wherein when the switching device is in the open position the switching device is configured to interrupt the electric current,
d. wherein the method comprises switching the switching device to the open or closed position to block and/or pass the electric current from the plurality of electrical lines to the powertrain of the vehicle.

An advantage of this embodiment is that an efficient blocking of the electric current from the plurality of electrical lines to the powertrain of the vehicle is provided without disconnecting the vehicle from the plurality of electrical lines. An advantage of this embodiment is that the connection and disconnection procedure for the vehicle is improved. An advantage of this embodiment is that a more efficient connection and disconnection procedure with regard to the plurality of electrical lines is provided, for example involving less time-consuming steps of reconnecting the vehicle to the electric road system, ERS. In some embodiments, the interface may comprise both the electrically operable switching device and the DC-to-DC converter, which is disclosed in further detail in the detailed description hereinbelow.

According to yet another advantageous embodiment of the method according to the first aspect, the connection and disconnection procedure comprises:
a. if one or more connection conditions is/are fulfilled, and if the vehicle is disconnected from the plurality of electrical lines (for example, if the vehicle is in a disconnected state in relation to the plurality of electrical lines), allowing the connection of the vehicle to the plurality of electrical lines, or expressed alternatively, allowing the vehicle to be connected to the plurality of electrical line.

According to still another advantageous embodiment of the method according to the first aspect, the one or more connection conditions comprises/comprise one or more of the group of:
a. the vehicle is on a proper path of a road associated with the electric road system;
b. the vehicle is located in a first predefined zone associated with the electric road system;
c. the vehicle is located outside a second predefined zone associated with the electric road system; and
d. a voltage associated with the electric current from the plurality of electrical lines to the powertrain of the vehicle is above a fourth threshold.

According to an advantageous embodiment of the method according to the first aspect, the connection and disconnection procedure comprises one or more of the steps of the group of:
a. if the one or more connection conditions is/are fulfilled and if the vehicle is disconnected from the plurality of electrical lines, connecting the vehicle to the plurality of electrical lines upon a request for a voluntary connection;
b. if the one or more connection conditions is/are fulfilled and if the vehicle is disconnected from the plurality of electrical lines, connecting the vehicle to the plurality of electrical lines upon a connection request from a user; and
c. if the one or more connection conditions is/are fulfilled and if the vehicle is disconnected from the plurality of electrical lines, automatically connecting the vehicle to the plurality of electrical lines.

According to a further advantageous embodiment of the method according to the first aspect, the connection and disconnection procedure comprises:
a. in the absence of the disconnect warning and if the vehicle is connected to the plurality of electrical lines, keeping the vehicle connected to the plurality of electrical lines.

According to another advantageous embodiment of the method according to the first aspect, the connection and disconnection procedure comprises:
a. upon a request for a voluntary disconnection and if the vehicle is connected to the plurality of electrical lines, disconnecting the vehicle from the plurality of electrical lines, for example in the absence of a disconnect warning or in the presence of a disconnect warning, or if a disconnect warning has occurred or been issued.

According to yet another advantageous embodiment of the method according to the first aspect, the plurality of electrical lines comprises or consists of, or is, a plurality of overhead electrical lines,
a. wherein the connection and disconnection procedure comprises the connection and disconnection of the vehicle to/from the plurality of overhead electrical lines of an electric road system,
b. wherein the connection and disconnection procedure comprises:
c. in response to a disconnect warning and if the vehicle is connected to the plurality of overhead electrical lines, blocking the electric current from the plurality of overhead electrical lines to a powertrain of the vehicle,
d. wherein the method comprises:
e. maintaining the connection of the vehicle to the plurality of overhead electrical lines while the electric current from the plurality of electrical lines to the powertrain of the vehicle is blocked in response to the disconnect warning.

An advantage of this embodiment is that the procedure of connection and disconnection of a vehicle to/from a plurality of overhead electrical lines of an electric road system, ERS, is improved. An advantage of this embodiment is that a more efficient connection and disconnection procedure with regard to the plurality of overhead electrical lines is provided, for example involving less time-consuming steps of reconnecting the vehicle to the plurality of overhead electrical lines of the electric road system, ERS.

The arrangement, or provision, of the plurality of electrical lines as a plurality of overhead electrical lines may be executed in manners known to the skilled person. In alternative embodiments, the plurality of electrical lines comprises or consists of, or is, a plurality of electrical lines arranged, or provided, or embedded, in the road associated with the electric road system, ERS. The plurality of electrical lines arranged, or provided, in the road, may be referred to as a plurality of ground-level electrical lines. The arrangement, or provision, of the plurality of electrical lines in the road may be performed in manners known to the skilled person. In some embodiments, the plurality of electrical lines comprises or consists of, or is, a plurality of electrical lines arranged, or provided, laterally in relation to the vehicle, i.e. the plurality of electrical lines is arranged beside the vehicle, for example along the lateral side or the road associated with the electric road system, ERS. The lateral arrangement, or provision, of the plurality of electrical lines may be executed in manners known to the skilled person. The plurality of electrical lines arranged, or provided, in the road, or beside the vehicle, may be referred to as a plurality of electrical rails. It may be defined that the plurality of electrical lines and/or the electric road system, ERS, are/is configured to provide an electric power supply to the vehicle.

According to a second aspect of the invention, the above mentioned and other objects are achieved with a computer program comprising instructions which, when the program is executed by a computer, cause the computer to carry out the method according to any one of the embodiments disclosed above or below. The advantages of the computer program according to the second aspect correspond to the above- or below-mentioned advantages of the method according to the first aspect and its embodiments.

According to a third aspect of the invention, the above mentioned and other objects are achieved with a computer-readable medium comprising instructions which, when the instructions are executed by a computer, cause the computer to carry out the method according to any one of the embodiments disclosed above or below. The advantages of the computer-readable medium according to the third aspect correspond to the above- or below-mentioned advantages of the method according to the first aspect and its embodiments.

According to an aspect of the present invention, the above-mentioned computer program and/or the computer-readable medium are/is configured to implement the method and its embodiments described herein.

According to a fourth aspect of the invention, the above mentioned and other objects are achieved with a control arrangement for a procedure of connection and disconnection of a vehicle to/from a plurality of electrical lines of an electric road system, wherein the connection and disconnection procedure comprises:
a. in response to a disconnect warning and if the vehicle is connected to the plurality of electrical lines, blocking the electric current from the plurality of electrical lines to a powertrain of the vehicle,
b. wherein the control arrangement is configured to:
c. maintain the connection of the vehicle to the plurality of electrical lines while the electric current from the plurality of electrical lines to the powertrain of the vehicle is blocked in response to the disconnect warning.

The advantages of the control arrangement according to the fourth aspect correspond to the above- or below-mentioned advantages of the method according to the first aspect and its embodiments.

It will be appreciated that all the embodiments described for the method aspects of the invention are applicable also to the control arrangement aspects the invention. Thus, all embodiments described for the method aspects of the invention may be performed by the control arrangement, which may include one or more control units, or one or more control devices. As mentioned above, the control arrangement and its embodiments have advantages corresponding to the advantages mentioned above for the method and its embodiments.

According to a fifth aspect of the invention, the above mentioned and other objects are achieved with a vehicle comprising a control arrangement according to any one of the embodiments disclosed above or below.

The advantages of the vehicle according to the fifth aspect correspond to the above- or below-mentioned advantages of the method according to the first aspect and its embodiments.

The vehicle may comprise a powertrain. The powertrain may be configured in accordance with any one of the embodiments disclosed above or below. The vehicle may comprise one or more of the group of: an electric battery and an electric battery pack. The powertrain of the vehicle may comprise one or more of the group of: an electric battery and an electric battery pack. The vehicle may comprise an interface for providing connection between the vehicle and the plurality of electrical lines of the electric road system. The interface may be configured in accordance with any one of the embodiments disclosed above or below.

The vehicle may be a wheeled vehicle, i.e. a vehicle having wheels. The vehicle may for example be a bus, a tractor vehicle, a heavy vehicle, a truck, or a car. The tractor vehicle may, or may be configured to, haul, or pull, a trailer. However, other types of vehicles are possible. The vehicle may be referred to as a motor vehicle. The vehicle may be an electric vehicle, EV, for example a hybrid vehicle or a hybrid electric vehicle, HEV, or a battery electric vehicle, BEV. Thus, a hybrid electric vehicle, HEV, and a battery electric vehicle, BEV, are versions, or examples, of an electric vehicle, EV. The EV may comprise one or more electric motors or electrical machines.

The above-mentioned features and embodiments of the method, the computer program, the computer-readable medium, the control arrangement and the vehicle, respectively, may be combined in various possible ways providing further advantageous embodiments.

Further advantageous embodiments of the method, the computer program, the computer-readable medium, the control arrangement and the vehicle according to the present invention and further advantages with the embodiments of the present invention emerge from the detailed description of embodiments.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1 is a schematic side view of an embodiment of the vehicle according to the fifth aspect of the invention;

FIG. 2 is a schematic front view of the vehicle of FIG. 1;

FIG. 3 is a schematic front view of the vehicle of FIG. 2 but with a connection device in a different position compared to FIG. 2;

FIG. 4 is a schematic diagram illustrating aspects of the vehicle of FIGS. 1 to 3;

FIG. 5 is a schematic flow chart illustrating aspects of embodiments of the method according to the first aspect of the invention;

FIG. 6 is another schematic flow chart illustrating aspects of embodiments of the method according to the first aspect of the invention;

FIG. 7 is a schematic view illustrating an embodiment of the control arrangement according to the fourth aspect of the invention, in which a method according to any one of the herein described embodiments may be implemented;

FIG. 8 is a schematic diagram illustrating an example of an electric battery unit or one or more electric batteries; and

FIG. 9 is a schematic diagram illustrating an example of an electric battery pack of a vehicle.

### DETAILED DESCRIPTION

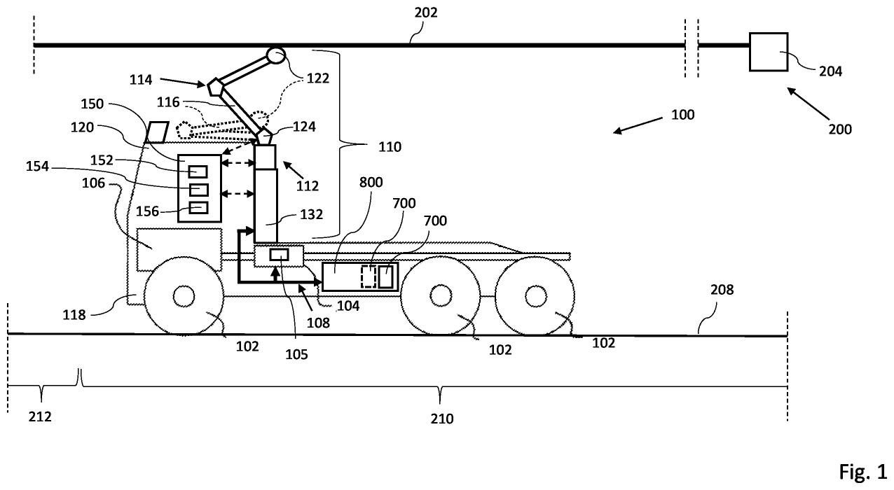

With reference to FIGS. 1 to 4, aspects of an embodiment of the vehicle 100 according to the fifth aspect of the invention are schematically illustrated. The vehicle 100 may be referred to as a motor vehicle 100. In FIGS. 1, 2 and 4, the vehicle 100 is illustrated as a tractor vehicle. The tractor vehicle may, or may be configured to, haul, or pull, a trailer. The tractor vehicle may be defined as hauler. The tractor vehicle may be a hauling, or pulling, vehicle. The tractor vehicle may be referred to as a mover, or a prime mover, for example connectable, or attachable, to a trailer. However, in other embodiments, the vehicle 100 may, for example, be a bus, a truck, a heavy truck or a car. Other types of vehicles are also possible. The vehicle 100 may comprise or consist of an electric vehicle, EV, for example a hybrid vehicle or a hybrid electric vehicle, HEV, or a battery electric vehicle, BEV. Thus, an HEV and a BEV are examples of an EV. The EV may comprise one or more electric motors 105.

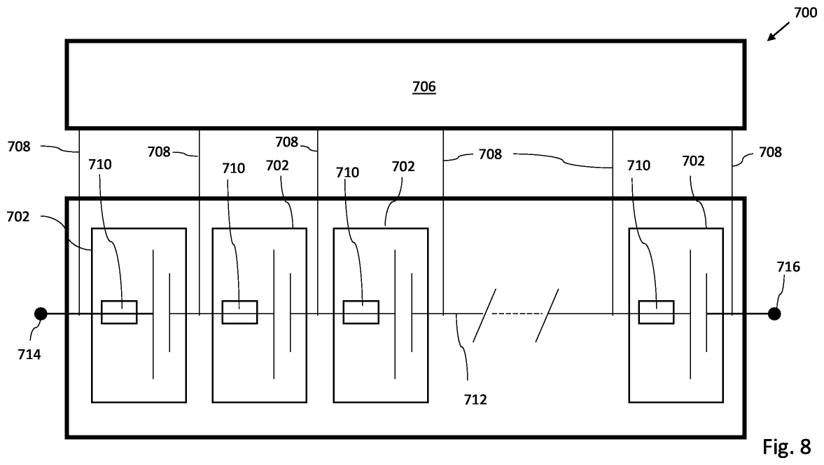

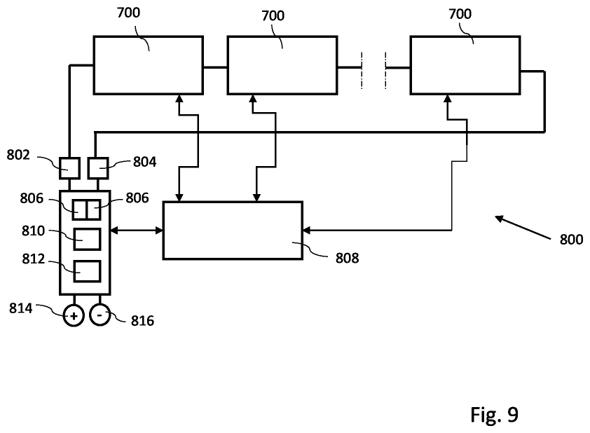

With reference to FIG. 1, the vehicle 100 may be a wheeled vehicle, i.e. a vehicle 100 having wheels 102. Only the wheels 102 on the left-hand side of the vehicle 100 are visible in FIG. 1. It is to be understood that the vehicle 100 may have fewer or more wheels than what is shown in FIG. 1. The vehicle 100 may comprise a powertrain 104, for example configured for one of an EV, HEV and BEV. The vehicle 100 may comprise, or carry, one or more electric batteries 700 and/or one or more electric battery packs 800, for example as disclosed below in connection with FIGS. 8 and 9. The vehicle 100 may include one or more electric motors 105 or electrical machines, for example to propel, or drive, the vehicle 100. For example, the powertrain 104 may include the one or more electric motors 105 or electrical machines. It may be defined that the powertrain 104 and/or the one or more electric motors 105 is/are configured to propel, or drive, the vehicle 100. It may be defined that the powertrain 104 includes the one or more electric batteries 700 and/or the one or more electric battery packs 800. It is to be understood that the vehicle 100 may include further unites, components, such as electrical and/or mechanical components, a combustion engine 106 and other devices required for a vehicle 100, such as for an EV, HEV or BEV.

With reference to FIG. 1, the vehicle 100 may include a vehicle electrical system 108. It may be defined that the vehicle electrical system 108 is configured for direct current. It may be defined that vehicle electrical system 108 is a vehicle high voltage system 108. It may be defined that the vehicle high voltage system 108 is configured for a high voltage, such as a voltage above 60 V, for example above 400 V, or above 450 V, such as above 650 V. For example, the vehicle high voltage system 108 may be configured for a voltage up to 1500 V and/or for a voltage above 1500 V. The electric power, or the electric current, for example the direct current, of the vehicle electrical system 108 (VCB) may be transferred at a high voltage, for example at one or more of the voltages levels mentioned above. The vehicle electrical system 108 may be configured to transfer the electric power, or the electric current, at a high voltage, for example at one or more of the voltages levels mentioned above. The vehicle electrical system 108 may be configured to transfer direct current. The vehicle electrical system 108 may be, or may be referred to as, a VCB.

With reference to FIG. 1, the vehicle electrical system 108 may be electrically connected, or connectable, to one or more electric batteries 700 and/or one or more electric battery packs 800, for example as illustrated in connection with FIGS. 8 and 9 hereinbelow. The one or more electric batteries 700 may be one or more high voltage batteries. The one or more electric battery packs 800 may be one or more high voltage battery packs. It may be defined that the one or more electric batteries 700 and/or the one or more electric battery packs 800 are/is configured for high voltage, for example for one or more of the voltages levels mentioned above. It may be defined that the one or more electric batteries 700 and/or the one or more electric battery packs 800 are/is held or carried by the vehicle 100. It may be defined that the vehicle 100 comprises one or more of the group of: an electric battery 700 and an electric battery pack 800. The vehicle electrical system 108 may be configured to electrically connect the one or more electric batteries 700 and/or the one or more electric battery packs 800 to the powertrain 104 of the vehicle 100. The vehicle electrical system 108 may be configured to electrically connect the one or more electric batteries 700 and/or the one or more electric battery packs 800 to the one or more electric motors 105 of the vehicle 100. It may be defined that the vehicle electrical system 108 is configured to transfer the electric power, or the electric current, for example between the one or more electric motors 105 (and/or the powertrain 104) and the one or more electric batteries 700 and/or electric battery packs 800

With reference to FIGS. 1 to 3, the vehicle 100 may comprise an interface 110 for providing connection between the vehicle 100 and a plurality of electrical lines 202 of an electric road system, ERS, 200. It may be defined that the interface 110 is configured to provide connection between the vehicle 100 and the plurality of electrical lines 202 of the electric road system, ERS, 200 in order to provide electric power to the vehicle 100 when the vehicle 100 is connected to the plurality of electrical lines 202, for example via the interface 110. It is to be understood that a plurality of electrical lines 202 means two or more electrical lines 202. It may be defined that the interface 110 is configured to provide one or more connections, e.g. two, between the electric vehicle 100 and the plurality of electrical lines 202. It may be defined that the interface 110 is configured to provide connection between the vehicle electrical system 108 of the vehicle 100 and the plurality of electrical lines 202 of the electric road system, ERS, 200.

In connection with the embodiments illustrated in FIGS. 1 to 3, the plurality of electrical lines 202 comprises or consists of a plurality of overhead electrical lines. The plurality of electrical lines 202 may be arranged, or provided, as a plurality of overhead electrical lines 202 in manners known to the skilled person. The plurality of overhead electrical lines 202 may be referred to as a plurality of electrical overhead lines 202. However, in alternative embodiments, the plurality of electrical lines may comprise or consist of a plurality of electrical lines arranged, or embedded, in the road associated with the electric road system, ERS. The plurality of electrical lines arranged in the road, may be referred to as a plurality of ground-level electrical lines. The plurality of electrical lines in the road may be provided in manners known to the skilled person. In some embodiments, the plurality of electrical lines may comprise or consists of a plurality of electrical lines arranged laterally in relation to the vehicle 100, i.e. the plurality of electrical lines is arranged beside the vehicle 100, for example along the lateral side or the road associated with the electric road system, ERS. The lateral arrangement of the plurality of electrical lines may be provided in manners known to the skilled person. The plurality of electrical lines arranged, or provided, in the road, or beside the vehicle 100, may be referred to as a plurality of electrical rails. It may be defined that the plurality of electrical lines 202 and/or the electric road system, ERS, are/is configured to provide an electric power supply to the vehicle 100.

With reference to FIGS. 1 to 4, it may be defined that the plurality of electrical lines 202 and/or the electric road system, ERS, 200 are/is configured to provide electric power to the vehicle 100, which is connected to the plurality of electrical lines 202, for example via the interface 110. It may be defined that the plurality of electrical lines 202 and/or the electric road system, ERS, 200 are/is configured to provide direct current, DC, power to the vehicle 100 connected to the plurality of electrical lines 202, for example via the interface 110. It may be defined that the plurality of electrical lines 202 and the electric road system 200 are configured for direct current, DC. It may be defined that the plurality of electrical lines 202 comprises or consists of two direct current lines 202, one 202 for DC+ and the other one 202 for DC−. The plurality of electrical lines 202 and the electric road system 200 may be configured for high voltage, such as a voltage above 60 V, for example above 400 V, or above 450 V, such as above 650 V. For example, the plurality of electrical lines 202 and the electric road system 200 may be configured for a voltage up to 1500 V and/or for a voltage above 1500 V.

With reference to FIGS. 1 to 3, the interface 110 may comprise a connection device 112. The connection device 112 may, for example, comprise a mechanical linkage and/or a foldable, or collapsible, configuration 114, for example a pantograph 116, for example movable in relation to a chassis 118 of the vehicle 100. In some embodiments, the connection device may comprise a telescopic configuration. However, other connection devices are also possible.

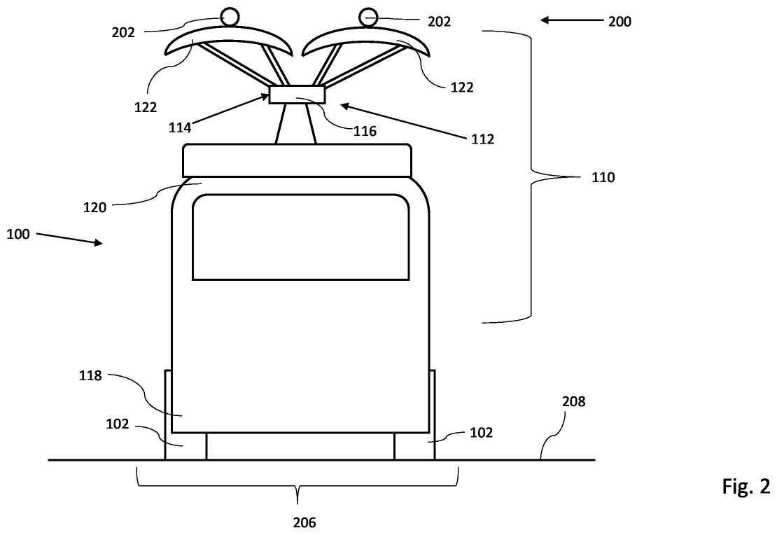

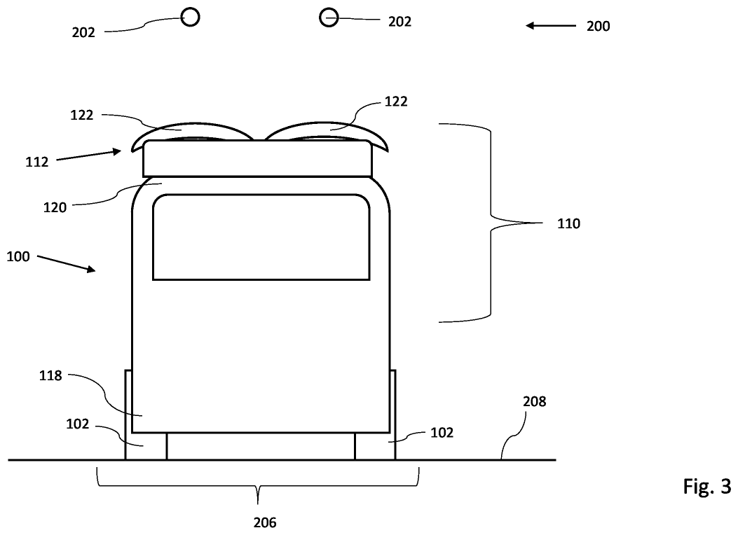

With reference to FIGS. 1 to 3, the connection device 112 is movable between at least one connection position, which is illustrated in FIGS. 1 and 2, and at least one disconnection position, which is illustrated in FIG. 3. The at least one disconnection position of the connection device 112 is also illustrated by dotted lines for the connection device 112 in FIG. 1. In the connection position, the connection device 112 and the vehicle 100 are connected to the plurality of electrical lines 202. In the disconnection position, the connection device 112 and the vehicle 100 are disconnected from the plurality of electrical lines 202. In the shown embodiment, the connection device 112 is mounted to the vehicle 100 in the region of a roof 120 of the vehicle 100. In some embodiments, the connection device 112 may be mounted and/or attached to the roof 120 of the vehicle 100. However, in some embodiments, the connection device 112 may mounted elsewhere to the vehicle 100.

With reference to FIGS. 1 to 4, the interface 110 may comprise a plurality of electrical contacts 122 spaced apart from one another. It is to be understood that a plurality of electrical contacts 122 means two or more electrical contacts 122. It may be defined that the plurality of electrical contacts 122 is configured for connection to the vehicle electrical system 108. It may be defined that the connection device 112 comprises the plurality of electrical contacts 122 spaced apart and/or electrically insulated from one another. The plurality of electrical contacts 122 may be configured to move together with the connection device 112, for example by being attached to the connection device 112 and/or to the foldable configuration 114 of the connection device 112. For example, one 122 of the plurality of electrical contacts 122 may be configured for electrical contact with one 202 of the plurality of electrical lines 202 while another one 122 of the electrical contacts 122 may be configured for electrical contact with another one 202 of the plurality of electrical lines 202.

In FIGS. 1 and 2, the connection device 112 is in the connection position, and the plurality of electrical contacts 122 of the connection device 112 is connected, i.e. electrically and mechanically connected, to the plurality of electrical lines 202. The connection position may be referred to as an extended and/or active position, which in the shown embodiment corresponds to an upper position in relation to the chassis 118 of the vehicle 100.

In FIG. 3, the connection device 112 is in the disconnection position, and the plurality of electrical contacts 122 of the connection device 112 is disconnected, i.e. electrically and mechanically disconnected, from the plurality of electrical lines 202, for example spaced apart from the plurality of electrical lines 202. The disconnection position (shown in FIG. 3) may be referred to as a retracted and/or inactive position, which in the shown embodiment corresponds to a lower position in relation to the chassis 118 of the vehicle 100 and/or in relation to the connection position of the connection device 112. In the shown embodiment, in the disconnection position of the connection device 112, the plurality of electrical contacts 122 are located closer to the chassis 118 of the vehicle 100, and for example closer to the roof 120 of the vehicle 100, in relation to the plurality of electrical contacts 122 when the connection device 112 is in the connection position. Each electrical contact 122 may be elongated and have a longitudinal extension, and the connection device 112 may be configured such that the longitudinal extension of each electrical contact 122 extends transversely to the direction of movement of the vehicle 100 when driven.

With reference to FIG. 1, the interface 110 may include an electric motor unit 124 for controlling the connection and disconnection of the vehicle 100 to/from the plurality of electrical lines 202. In some embodiments, the interface 110 may include a pneumatic or hydraulic system for controlling the connection and disconnection of the vehicle 100 to/from the plurality of electrical lines 202. The electric motor unit 124 may be configured to control the connection device 112. The electric motor unit 124 may be configured to move the connection device 112 in relation to the chassis 118 of the vehicle 100. Thus, the electric motor unit 124 may be configured to move the connection device 112 between the connection position and the disconnection position. The electric motor unit 124 may comprise a direct current motor. As mentioned above, in some embodiments the interface 110 may include a pneumatic or hydraulic system, and then the pneumatic or hydraulic system may be configured to control the connection device 112 in the ways mentioned above for the electric motor unit 124.

With reference to FIG. 2, the interface 110 may be electrically connected, or configured to be electrically connected, to the vehicle electrical system 108 disclosed above.

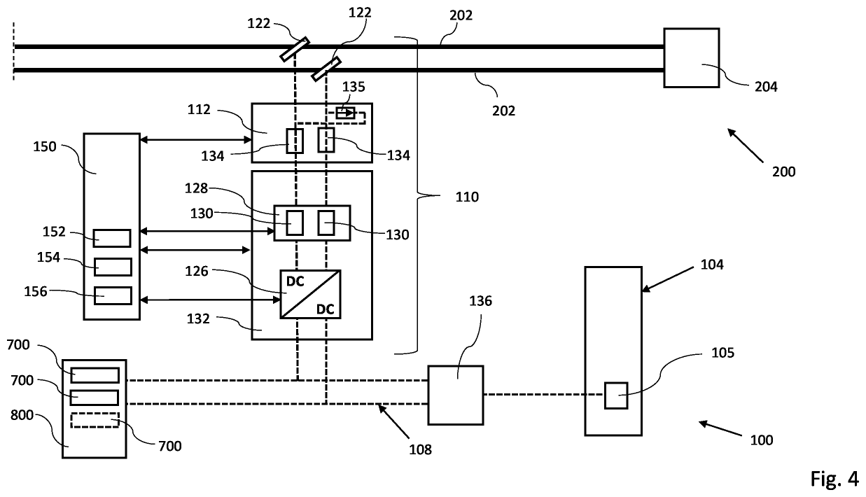

With reference to FIG. 4, an electrical circuit configuration of the interface 110 is schematically illustrated. In FIG. 4, the connection device 112 is in the connection position, and the plurality of electrical contacts 122 of the connection device 112 is connected to the plurality of electrical lines 202 of the electric road system, ERS, 200. The electric road system, ERS, 200 may include or be connected to a grid power supply 204. The interface 110 may include a DC-to-DC converter 126. The DC-to-DC converter 126 may be configured to electrically connect the plurality of electrical contacts 122 to the vehicle electrical system 108.

With reference to FIG. 4, the interface 110 may include an electrically operable switching device 128 switchable between an open position and a closed position. The fact that the switching device 128 is electrically operable means that the switching device is configured to be electrically operated or controlled, for example by a control arrangement 150. When the switching device 128 is in the closed position, the switching device 128 is configured to allow the electric current to pass. When the switching device 128 is in the open position, the switching device 128 is configured to interrupt the electric current. The switching device 128 may be configured to electrically connect the plurality of electrical contacts 122 to the vehicle electrical system 108. More specifically, in the shown embodiment, the switching device 128 is configured to electrically connect the plurality of electrical contacts 122 to the DC-to-DC converter 126. In alternative embodiments, the switching device 128 may be configured to electrically connect the DC-to-DC converter 126 to the vehicle electrical system 108. The switching device 128 may include a plurality of switches 130, such as electrical switches. It is to be understood that a plurality of switches 130 means two or more switches 130. For example, one 130 of the plurality of switches 130 may be provided for DC− while another one 130 of the plurality of switches 130 may be provided for DC+.

With reference to FIG. 4, the interface 110 may comprise a tower 132 to which the connection device 112 may be mounted and/or attached. The tower 132 may be mounted and/or attached to the chassis 118 of the vehicle 100, or to any other frame or part of the vehicle 100. The tower 132 may house one or more of the DC-to-DC converter 126 and the switching device 128. The interface 110 may comprise a plurality of fuses 134 configured to electrically connect the plurality of electrical contacts 122 to the vehicle electrical system 108, when each fuse 134 of the plurality of fuses 134 is a closed circuit and not an open circuit (for example when melted), the open circuit interrupting an electric current. More specifically, in the shown embodiment, the plurality of fuses 134 is configured to electrically connect the plurality of electrical contacts 122 to the DC-to-DC converter 126 and/or the switching device 128. The plurality of fuses 134 may be arranged and/or located in the connection device 112 or between the connection device 112 and the tower 132. In some embodiments, the interface 110 includes an overvoltage protector 135, which may be arranged and/or located in the connection device 112.

With reference to FIG. 4, in the shown embodiment, the vehicle electrical system 108 is electrically connected to the one or more electric batteries 700 and/or one or more electric battery packs 800, for example as illustrated below in connection with FIGS. 8 and 9. In the shown embodiment, the vehicle electrical system 108 is electrically connected to the one or more electric motors 105 of the vehicle 100. The one or more electric motors 105 may be located in the transmission of the vehicle 100, or elsewhere in the vehicle 100. The vehicle electrical system 108 may include an inverter 136, for example referred to as a power inverter 136. As already stated above, the vehicle electrical system 108 may be configured to electrically connect the one or more electric batteries 700 and/or the one or more electric battery packs 800 to the one or more electric motors 105 of the vehicle 100, for example via the inverter 136. As mentioned above, the powertrain 104 of the vehicle 100 may include the one or more electric motors 105. The powertrain 104 may comprise the inverter 136. As mentioned above, the powertrain 104 of the vehicle 100 may even include the one or more electric batteries 700 and/or the one or more electric battery packs 800.

With reference to FIGS. 1 and 4, the vehicle 100 comprises a control arrangement 150, for example according to any one of the embodiments disclosed below or above. The control arrangement 150 may be configured to control the interface 110. The control arrangement 150 may be configured to control the DC-to-DC converter 126. The control arrangement 150 may be configured to control, or switch, the switching device 128. The control arrangement 150 may be configured to control the connection device 112. The control arrangement 150 may be configured to control the electric motor unit 124 of the interface 110. In some embodiments, the control arrangement 150 may be configured to control the above-mentioned pneumatic or hydraulic system of the interface 110. The control arrangement 150 may be configured to control the movement of the plurality of electrical contacts 122, for example by controlling the connection device 112 and/or the electric motor unit 124. The control arrangement 150 is disclosed in further detail hereinbelow.

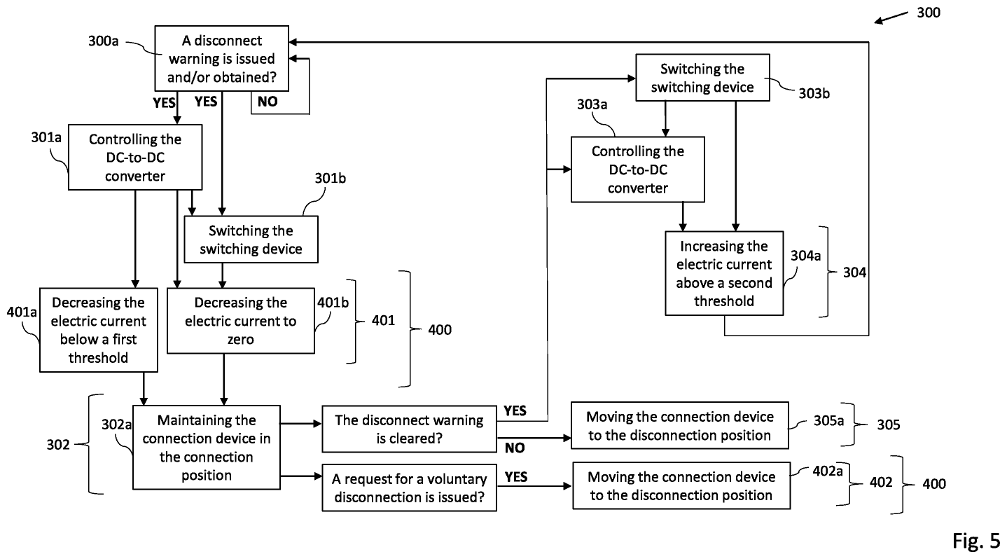

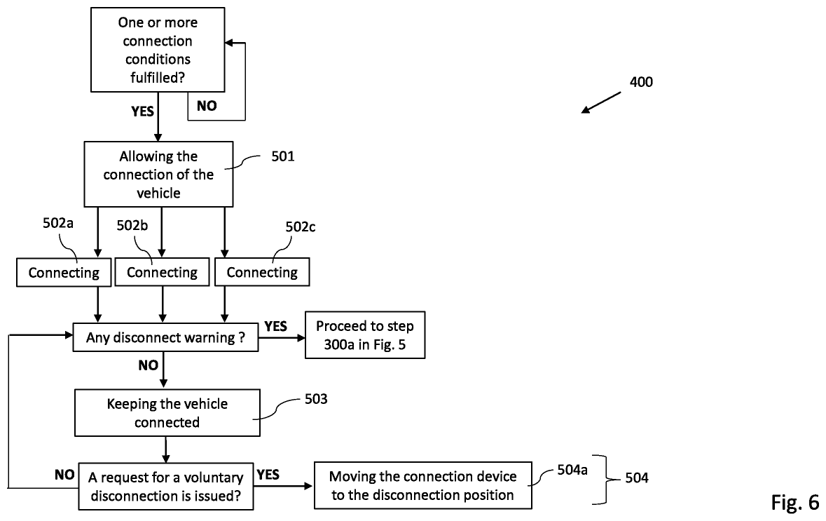

With reference to FIGS. 5 and 6, aspects of embodiments of the method 300 for a procedure 400 of connection and disconnection of a vehicle 100 to/from a plurality of electrical lines 202 of an electric road system, ERS, 200 according to the first aspect are schematically illustrated.

With reference to FIG. 5, the connection and disconnection procedure 400 comprises:
a. in response, or in reaction, to a disconnect warning and if the vehicle 100 is connected to the plurality of electrical lines 202 (for example, if the vehicle 100 is in a connected state in relation to the plurality of electrical lines 202, for example as illustrated in FIGS. 1 and 2), blocking 401 the electric current from the plurality of electrical lines 202 to a powertrain 104 of the vehicle 100.

The step of blocking 401 the electric current from the plurality of electrical lines 202 to the powertrain 104 of the vehicle 100 may involve interrupting the electric current from the plurality of electrical lines 202 to the powertrain 104 of the vehicle 100. For some embodiments, the disconnect warning is issued, or occurs (see step 300a in FIG. 5), before the step of blocking 401 the electric current from the plurality of electrical lines 202 to a powertrain 104 of the vehicle 100. In some embodiments, the connection and disconnection procedure 400 may comprise obtaining or receiving a disconnect warning. In some embodiments, the blocking 401 of the electric current from the plurality of electrical lines 202 to the powertrain 104 of the vehicle 100 comprises blocking the electric current from the plurality of electrical contacts 122 to the powertrain 104 of the vehicle 100.

With reference to FIG. 5, the method 300 comprises:
a. maintaining 302 the connection of the vehicle 100 to the plurality of electrical lines 202 while the electric current from the plurality of electrical lines 202 to the powertrain 104 of the vehicle 100 is blocked 401 (for example interrupted) in response to the disconnect warning.

It is to be understood that the connection of the vehicle 100 to the plurality of electrical lines 202 of the electric road system, ERS, 200 according to the connection and disconnection procedure 400 is both mechanical (or physical) and electrical, i.e. both a mechanical connection and an electrical connection are provided between the vehicle 100 and the plurality of electrical lines 202. Thus, since the connection (i.e. both the mechanical and electrical connection) of the vehicle 100 to the plurality of electrical lines 202 is maintained according to embodiments of the method 300 according to the first aspect, the electric current from the plurality of electrical lines 202 to the vehicle 100 per se is not blocked. Instead, the electric current from the plurality of electrical lines 202 to the powertrain 104 of the vehicle 100 is blocked 401 according to embodiments of the method 300 according to the first aspect, while maintaining the connection (i.e. both the mechanical and electrical connections) of the vehicle 100 to the plurality of electrical lines 202.

It may be defined that the blocking 401 of the electric current from the plurality of electrical lines 202 to the powertrain 104 of the vehicle 100 is performed in the vehicle 100. It may be defined that the blocking 401 of the electric current from the plurality of electrical lines 202 to the powertrain 104 of the vehicle 100 is performed in the vehicle 100, or in the interface 110, but outside the plurality of electrical contacts 122. It may be defined that the blocking 401 of the electric current from the plurality of electrical lines 202 to the powertrain 104 of the vehicle 100 is performed in the vehicle 100 but outside the plurality of electrical contacts 122 and outside the connection device 112. For example, the blocking 401 of the electric current from the plurality of electrical lines 202 to the powertrain 104 of the vehicle 100 may be performed in the tower 132 of the interface 110, or elsewhere in the vehicle 100, but outside the plurality of electrical contacts 122 and/or outside the connection device 112.

For some embodiments, when the vehicle 100 comprises an interface 110 for providing connection between the vehicle 100 and the plurality of electrical lines 202, and when the interface 110 comprises a plurality of electrical contacts 122, it may be defined that the step of blocking 401 comprises blocking the electric current from the plurality of electrical contacts 122 to the powertrain 104 of the vehicle 100 in order to block 401 the electric current from the plurality of electrical lines 202 to the powertrain 104 of the vehicle 100.

With reference to FIGS. 1 and 2, the disconnect warning may comprise one or more of the group of:
a. the vehicle 100 is about to leave a proper path 206 of a road 208 associated with the electric road system, ERS, 200;
b. a voltage associated with the electric current from the plurality of electrical lines 202 to the powertrain 104 of the vehicle 100 falls below a third threshold;
c. the vehicle 100 is about to leave, or exit, a first predefined zone 210 associated with the electric road system, ERS, 200; and
d. the vehicle 100 is about to enter a second predefined zone 212 associated with the electric road system, ERS, 200.

A proper path 206, which is schematically illustrated in FIGS. 2 and 3, may be a path 206 along the extension of the plurality of electrical lines 202 on which the vehicle 100 may properly, for example also safely, stay connected to the plurality of electrical lines 202, for example by way of the interface 110 disclosed above. Further, the proper path 206 may be a path 206 along the extension of the plurality of electrical lines 202 on which the vehicle 100 may properly, for example also safely, connect, for example perform one or more steps for connecting, to the plurality of electrical lines 202, for example by way of the interface 110 disclosed above. The proper path 206 may be defined and/or monitored by a lane keep/keeping assist/assistance, LKA, system and/or a lane departure warning system, LDWS, and/or a global positioning system, GPS.

The meaning of that the vehicle 100 is about to leave the proper path 206 or the first predefined zone 210 may correspond to that the vehicle 100 will shortly, or within a short time period, leave the proper path 206 or the first predefined zone 210. Expressed alternatively, the leaving of the proper path 206 or the first predefined zone 210 is impending or imminent. The meaning of that the vehicle 100 is about to enter the second predefined zone 212 may correspond to that the vehicle 100 will shortly, or within a short time period, enter the second predefined zone 212. Expressed alternatively, the entry of the second predefined zone 212 is impending or imminent.

With reference to FIG. 1, the first predefined zone 210 may be a zone for which the vehicle 100 is registered as a user, for example via a subscription, and allowed to use the electric road system, ERS, 200. The second predefined zone 212 may be a zone for which the vehicle 100 is not registered as a user, for example lacks a subscription, and thus is not allowed to use the electric road system, ERS. The first and/or second predefined zones 210, 212 may be defined and/or monitored by a global positioning system, GPS, or by a cellular communication network, or by a combination thereof, or any other system or systems.

With reference to FIGS. 2 and 5, when the vehicle 100 comprises an interface 110 providing connection between the vehicle 100 and the plurality of electrical lines 202, and when the interface 110 includes a connection device 112, for example according to any one of the embodiments disclosed above, the step of maintaining 302 the connection of the vehicle 100 to the plurality of electrical lines 202, while the electric current from the plurality of electrical lines 202 to the powertrain 104 of the vehicle 100 is blocked 401 in response to the disconnect warning, may comprise maintaining 302a the connection device 112 in the connection position (for example as illustrated in FIGS. 1 and 2).

With reference to FIG. 5, in some embodiments of the method 300 according to the first aspect, the blocking 401 of the electric current from the plurality of electrical lines 202 to the powertrain 104 of the vehicle 100 may comprise decreasing 401a the electric current from the plurality of electrical lines 202 to the powertrain 104 of the vehicle 100 below a first threshold.

With reference to FIG. 5, in some embodiments of the method 300 according to the first aspect, the blocking 401 of the electric current from the plurality of electrical lines 202 to the powertrain 104 of the vehicle 100 may comprise decreasing 401b the electric current from the plurality of electrical lines 202 to the powertrain 104 of the vehicle 100 to zero.

With reference to FIGS. 4 and 5, when vehicle 100 comprises an interface 110 for providing connection between the vehicle 100 and the plurality of electrical lines 202, and when the interface 110 comprises a DC-to-DC converter 126, embodiments of the method 300 according to the first aspect may comprise controlling 301a the DC-to-DC converter 126 to block 401 the electric current from the plurality of electrical lines 202 to the powertrain 104 of the vehicle 100. Some embodiments may comprise controlling the DC-to-DC converter 126 to block the electric current from the plurality of electrical contacts 122 to the powertrain 104 of the vehicle 100 in order to block 401 the electric current from the plurality of electrical lines 202 to the powertrain 104 of the vehicle 100.

With reference to FIGS. 4 and 5, when vehicle 100 comprises an interface 110 for providing connection between the vehicle 100 and the plurality of electrical lines 202, and when the interface 110 comprises an electrically operable switching device 128 switchable between an open position and a closed position, embodiments of the method 300 according to the first aspect may comprise switching 301b the switching device 128 to the open position to block 401 the electric current from the plurality of electrical lines 202 to the powertrain 104 of the vehicle 100. Some embodiments may comprise switching the switching device 128 to the open position to block the electric current from the plurality of electrical contacts 122 to the powertrain 104 of the vehicle 100 in order to block 401 the electric current from the plurality of electrical lines 202 to the powertrain 104 of the vehicle 100.

With reference to FIG. 5, in some embodiments, the step of controlling 301a the DC-to-DC converter 126 and the step of switching 301b the switching device 128 to block the electric current from the plurality of electrical lines 202 to the powertrain 104 may be combined, for example for safety reasons. When combining the step of controlling 301a the DC-to-DC converter 126 and the step of switching 301b the switching device 128, it may be advantageous to first control 301a the DC-to-DC converter 126 to block 401 the electric current from the plurality of electrical lines 202 to the powertrain 104 of the vehicle 100 and subsequently switch 301b the switching device 128 to the open position, since this process, or strategy, may reduce the wear on the switching device 128 (for example, wear in the form of arcing or welding), since the switching device 128 is switched to the open position when the circuit is already opened, or interrupted, by the DC-to-DC converter 126.

With reference to FIGS. 2 and 5, some embodiments of the method 300 according to the first aspect may comprise:

when the connection of the vehicle 100 to the plurality of electrical lines 202 is maintained 302 and the disconnect warning is cleared (for example, cleared within a time period), passing 304 the electric current from the plurality of electrical lines 202 to the powertrain 104 of the vehicle 100.

The phrase “the disconnect warning is cleared” may alternatively be expressed as “the disconnect warning is withdrawn”, “the disconnect warning is disabled”, or “the disconnect warning disappears”.

It may be defined that the passing 304 of the electric current from the plurality of electrical lines 202 to the powertrain 104 of the vehicle 100 is performed in the vehicle 100. It may be defined that the passing 304 of the electric current from the plurality of electrical lines 202 to the powertrain 104 of the vehicle 100 is performed in the vehicle 100 but outside the plurality of electrical contacts 122. It may be defined that the passing 304 of the electric current from the plurality of electrical lines 202 to the powertrain 104 of the vehicle 100 is performed in the vehicle 100 but outside the plurality of electrical contacts 122 and outside the connection device 112. For example, the passing 304 of the electric current from the plurality of electrical lines 202 to the powertrain 104 of the vehicle 100 may be performed in the tower 132 of the interface 110, or elsewhere in the vehicle 100, but outside the plurality of electrical contacts 122 and/or outside the connection device 112.

For some embodiments, when the vehicle 100 comprises an interface 110 for providing connection between the vehicle 100 and the plurality of electrical lines 202, and when the interface 110 comprises a plurality of electrical contacts 122, it may be defined that the passing 304 of the electric current from the plurality of electrical lines 202 to the powertrain 104 of the vehicle 100 comprises passing the electric current from the plurality of electrical contacts 122 to the powertrain 104 of the vehicle 100 in order to pass 304 the electric current from the plurality of electrical lines 202 to the powertrain 104 of the vehicle 100.

With reference to FIG. 5, in some embodiments of the method 300 according to the first aspect, the passing 304 of the electric current from the plurality of electrical lines 202 to the powertrain 104 of the vehicle 100 may comprise increasing 304a the electric current from the plurality of electrical lines 202 to the powertrain 104 of the vehicle 100 above a second threshold. It may be defined that the increasing 304a of the electric current from the plurality of electrical lines 202 to the powertrain 104 of the vehicle 100 is performed in the vehicle 100, for example on any of the locations mentioned above for the passing 304 of the electric current from the plurality of electrical lines 202 to the powertrain 104.

With reference to FIGS. 4 and 5, when vehicle 100 comprises an interface 110 for providing connection between the vehicle 100 and the plurality of electrical lines 202, and when the interface 110 comprises a DC-to-DC converter 126, embodiments of the method 300 according to the first aspect may comprise controlling 303a the DC-to-DC converter 126 to pass 304 the electric current from the plurality of electrical lines 202 to the powertrain 104 of the vehicle 100. Some embodiments may comprise controlling the DC-to-DC converter 126 to pass the electric current from the plurality of electrical contacts 122 to the powertrain 104 of the vehicle 100 in order to pass 304 the electric current from the plurality of electrical lines 202 to the powertrain 104 of the vehicle 100

With reference to FIGS. 4 and 5, when vehicle 100 comprises an interface 110 for providing connection between the vehicle 100 and the plurality of electrical lines 202, and when the interface 110 comprises an electrically operable switching device 128 switchable between an open position and a closed position, embodiments of the method 300 according to the first aspect may comprise switching 303b the switching device 128 to the closed position to pass 304 the electric current from the plurality of electrical lines 202 to the powertrain 104 of the vehicle 100. Some embodiments may comprise switching the switching device 128 to pass the electric current from the plurality of electrical contacts 122 to the powertrain 104 of the vehicle 100 in order to pass 304 the electric current from the plurality of electrical lines 202 to the powertrain 104 of the vehicle 100.

With reference to FIG. 5, in some embodiments, the step of controlling 303a the DC-to-DC converter 126 to pass 304 the electric current and the step of switching 303b the switching device 128 to pass 304 the electric current may be combined, for example when both the DC-to-DC converter 126 and the switching device 128 are blocking 401 the electric current in previous steps for safety reasons. When combining the step of controlling 303a the DC-to-DC converter 126 and the step of switching 303b the switching device 128 to pass 304 the electric current, it may be advantageous to first switch 303b the switching device 128 to the closed position and subsequently control 303a the DC-to-DC converter 126 to pass 304 the electric current from the plurality of electrical lines 202 to the powertrain 104 of the electric vehicle 100.

With reference to FIG. 5, some embodiments of the method 300 according to the first aspect may comprise:
a. when the connection of the vehicle 100 to the plurality of electrical lines 202 is maintained 302 and the disconnect warning is not cleared (for example, not cleared within a time period), disconnecting 305 the vehicle 100 from the plurality of electrical lines 202 while the electric current from the plurality of electrical lines 202 to the powertrain 104 of the vehicle 100 is blocked 401 in response to the disconnect warning.

With reference to FIGS. 2 and 5, when the vehicle 100 comprises an interface 110 providing connection between the vehicle 100 and the plurality of electrical lines 202, and when the interface 110 includes a connection device 112, for example according to any one of the embodiments disclosed above, the step of disconnecting 305 the vehicle 100 from the plurality of electrical lines 202, while the electric current from the plurality of electrical lines 202 to the powertrain 104 of the vehicle 100 is blocked 401 in response to the disconnect warning, may comprise moving 305a the connection device 112 from the connection position (for example as illustrated in FIGS. 1 and 2) to the disconnection position (for example as illustrated in FIG. 3).

It is of importance to disconnect 305 the vehicle 100 from the plurality of electrical lines 202 when the disconnect warning is not cleared. For example, if the vehicle 100 leaves the proper path 206 of the road 208 associated with the electric road system, ERS, 200 without disconnecting 305 the vehicle 100, for example without moving 305a the connection device 112 from the connection position (for example as illustrated in FIGS. 1 and 2) to the disconnection position (for example as illustrated in FIG. 3), both the plurality of electrical lines 202 and the connection device 112 may be damaged. For example, the connection device 112 may hit at least one electrical line 202 of the plurality of electrical lines 202 from the side, or laterally, or may be caught between the plurality of electrical lines 202, for example with regard to a plurality of overhead electrical lines 202 and a plurality of lateral electrical lines. With regard to a plurality of ground-level electrical lines, the connection device may be damaged against the road 208, or by any object on the road 208, if it stays to loo long in the connected position, and it is thus advisable to swiftly move the connection device to the disconnect and/or retracted position if the vehicle 100 leaves the proper path 206 of the road 208.

With reference to FIG. 5, for some embodiments of the method 300 according to the first aspect, the connection and disconnection procedure 400 may comprise:
a. upon a request for a voluntary disconnection and if the vehicle 100 is connected to the plurality of electrical lines 202, disconnecting 402 the vehicle 100 from the plurality of electrical lines 202, for example in the absence of a disconnect warning, or in the presence of a disconnect warning.

The request for a voluntary disconnection may, for example, be issued by a user or operator, for example by a driver, or a passenger, of the vehicle 100, or by a remote operator, or by a control system. With reference to FIGS. 2 and 5, when the vehicle 100 comprises an interface 110 providing connection between the vehicle 100 and the plurality of electrical lines 202, and when the interface 110 includes a connection device 112, for example according to any one of the embodiments disclosed above, the step of disconnecting 402 the vehicle 100 from the plurality of electrical lines 202 may comprise moving 402a the connection device 112 from the connection position (for example as illustrated in FIGS. 1 and 2) to the disconnection position (for example as illustrated in FIG. 3). For some embodiments, the request for a voluntary disconnection is issued before the step of disconnecting 402 the vehicle 100 from the plurality of electrical lines 202. In some embodiments, the connection and disconnection procedure 400 may comprise obtaining or receiving the request for a voluntary disconnection.

With reference to FIG. 6, for some embodiments of the method 300 according to the first aspect, the connection and disconnection procedure 400 may comprise:
a. if one or more connection conditions is/are fulfilled, or met, and if the vehicle 100 is disconnected (for example, if the vehicle 100 is in a disconnected state in relation to the plurality of electrical lines 202, for example as illustrated in FIG. 3) from the plurality of electrical lines 202, allowing 501 the connection of the vehicle 100 to the plurality of electrical lines 202 (or expressed alternatively, allowing the vehicle 100 to be connected to the plurality of electrical line 202).

For some embodiments, the one or more connection conditions may comprise one or more of the group of:
a. the vehicle 100 is on a proper path 206 of a road 208 associated with the electric road system, ERS, 200;
b. the vehicle 100 is located in a first predefined zone 210 associated with the electric road system, ERS, 200;
c. the vehicle 100 is located outside a second predefined zone 212 associated with the electric road system, ERS, 200; and
d. a voltage associated with the electric current from the plurality of electrical lines 202 to the powertrain 104 of the vehicle 100 is above a fourth threshold.

With reference to FIG. 6, for some embodiments, the connection and disconnection procedure 400 may comprise one or more of the steps of the group of:
a. if the one or more connection conditions is/are fulfilled, for example if every one of the one or more connection conditions is fulfilled, and if the vehicle 100 is disconnected from the plurality of electrical lines 202 (for example as illustrated in FIG. 3), connecting 502a the vehicle 100 to the plurality of electrical lines 202 upon a request for a voluntary connection;
b. if the one or more connection conditions is/are fulfilled, for example if every one of the one or more connection conditions is fulfilled, and if the vehicle 100 is disconnected from the plurality of electrical lines 202 (for example as illustrated in FIG. 3), connecting 502b the vehicle 100 to the plurality of electrical lines 202 upon a connection request from a user, or an operator; and
c. if the one or more connection conditions is/are fulfilled, for example if every one of the one or more connection conditions is fulfilled, and if the vehicle 100 is disconnected from the plurality of electrical lines 202 (for example as illustrated in FIG. 3), automatically connecting 502c the vehicle 100 to the plurality of electrical lines 202.

The request for a voluntary connection may, for example, be issued by a user or operator, for example by the driver, or a passenger, of the vehicle 100, or by a remote operator, or by a control system. The connection request from a user may be issued by a driver, or a passenger, of the vehicle 100, or by a remote operator. For some embodiments, each connection request, or request for connection, is issued before the step of connecting the vehicle 100 to the plurality of electrical lines 202. In some embodiments, the connection and disconnection procedure 400 may comprise obtaining or receiving the connection request, or the request for connection.

With reference to FIG. 6, according to embodiments of the method according first aspect, after the connection 502a, 502b, 502c of the vehicle 100 to the plurality of electrical lines 202, the step of passing electric current from the plurality of electrical lines 202 to the powertrain 104 of the vehicle 100 may be performed, for example in a corresponding manner as disclosed above in connection with the steps 303a, 303b and 304 in FIG. 5.

With reference to FIG. 6, for some embodiments, the connection and disconnection procedure 400 may comprise:
a. in the absence of the disconnect warning and if the vehicle 100 is connected to the plurality of electrical lines 202, keeping 503 the vehicle 100 connected to the plurality of electrical lines 202.

With reference to FIG. 6, for some embodiments, the connection and disconnection procedure 400 may comprise:
a. upon a request for a voluntary disconnection and if the vehicle 100 is connected to the plurality of electrical lines 202, disconnecting 504 the vehicle 100 from the plurality of electrical lines 202, for example in the absence of a disconnect warning or in the presence of a disconnect warning, or if a disconnect warning has occurred or been issued.

As mentioned above, the request for a voluntary disconnection may, for example, be issued by a user or operator, for example by a driver, or a passenger, of the vehicle 100, or by a remote operator, or by a control system. With reference to FIGS. 2 and 6, when the vehicle 100 comprises an interface 110 providing connection between the vehicle 100 and the plurality of electrical lines 202, and when the interface 110 includes a connection device 112, for example according to any one of the embodiments disclosed above, the step of disconnecting 504 the vehicle 100 from the plurality of electrical lines 202 may comprise moving 504a the connection device 112 from the connection position (for example as illustrated in FIGS. 1 and 2) to the disconnection position (for example as illustrated in FIG. 3). For some embodiments, the request for a voluntary disconnection is issued before the step of disconnecting 504 the vehicle 100 from the plurality of electrical lines 202. In some embodiments, the connection and disconnection procedure 400 may comprise obtaining or receiving the request for a voluntary disconnection.

With reference to FIG. 6, according to embodiments of the method according first aspect, before the disconnection 504 of the vehicle 100 from the plurality of electrical lines 202, the step of blocking the electric current from the plurality of electrical lines 202 to the powertrain 104 of the vehicle 100 may be performed, for example in a corresponding manner as disclosed above in connection with the steps 301a, 301b and 401 in FIG. 5.

It is to be understood that the disconnection of the vehicle 100 from the plurality of electrical lines 202 of the electric road system, ERS, 200 according to the connection and disconnection procedure 400 is both mechanical (or physical) and electrical, i.e. both an electrical disconnection and a mechanical disconnection of the vehicle 100 from the plurality of electrical lines 202 are performed or executed.

Unless disclosed otherwise, it should be noted that the method or procedure steps illustrated in FIGS. 4 and 5 and described herein do not necessarily have to be executed in the order illustrated in FIGS. 4 and 5. The steps may essentially be executed in any suitable order. Further, one or more steps may be added without departing from the scope of the appended claims. One or more steps may be excluded from the method or procedure without departing from the scope of the appended claims.

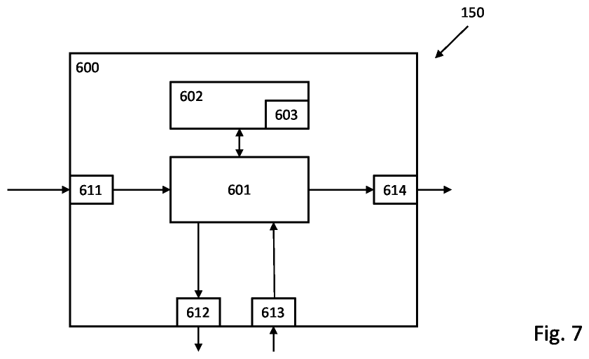

With reference to FIGS. 1 and 7, aspects of embodiments of the control arrangement 150 for a procedure of connection and disconnection of a vehicle 100 to/from a plurality of electrical lines 202 of an electric road system, ERS, 200 according to the fourth aspect of the invention are schematically illustrated, wherein the connection and disconnection procedure 400 comprises: in response to a disconnect warning and if the vehicle 100 is connected to the plurality of electrical lines 202, blocking 401 the electric current from the plurality of electrical lines 202 to a powertrain 104 of the vehicle 100. The control arrangement 150 is configured to maintain the connection of the vehicle 100 to the plurality of electrical lines 202 while the electric current from the plurality of electrical lines 202 to the powertrain 104 of the vehicle 100 is blocked 401 in response to the disconnect warning.

With reference to FIGS. 1 and 4, the illustrated embodiment of the control arrangement 150 includes a first control unit 152 for controlling the DC-to-DC converter 126 to block and/or pass the electric current from the plurality of electrical lines 202 (and/or from the plurality of electrical contacts 122) to the powertrain of the vehicle 100. The shown embodiment of the control arrangement 150 includes a second control unit 154 for controlling the switching device 128 to switch between the open position and the closed position. The shown embodiment of the control arrangement 150 includes a third control unit 156 for controlling the connection device 112, more specifically, for example, controlling the movement of the connection device 112, for example controlling the movement of the connection device 112 between the connection position and the disconnection position disclosed above. For example, the third control unit 156 may be configured to control the electric motor unit 124 of the interface 110 in order to control the connection device 112 and the movement of the connection device 112. In some embodiments, the third control unit 156 may be configured to control the above-mentioned pneumatic or hydraulic system of the interface 110 in order to control the connection device 112 and the movement of the connection device 112.

FIG. 7 shows in schematic representation an embodiment of the control arrangement 150 according to the fourth aspect of the invention, which may include a control unit 600, which may correspond to or may include one or more of the above-mentioned units 152, 154, 156 of the control arrangement 150. The control unit 600 may comprise a computing unit 601, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 601 is connected to a memory unit 602 arranged in the control unit 600. The memory unit 602 provides the computing unit 601 with, for example, the stored program code and/or the stored data which the computing unit 601 requires to be able to perform computations. The computing unit 601 is also arranged to store partial or final results of computations in the memory unit 602.

With reference to FIG. 7, in addition, the control unit 600 may be provided with devices 611, 612, 613, 614 for receiving and transmitting input and output signals. These input and output signals can contain waveforms, impulses, or other attributes which, by means of the devices 611, 613 for the reception of input signals, can be detected as information and can be converted into signals which can be processed by the computing unit 601. These signals are then made available to the computing unit 601. The devices 612, 614 for the transmission of output signals are arranged to convert signals received from the computing unit 801 in order to create output signals by, for example, modulating the signals, which can be transmitted to other parts of and/or systems in the vehicle 100.

Each of the connections to the devices for receiving and transmitting input and output signals can be constituted by one or more of a cable; a data bus, such as a CAN bus (Controller Area Network bus), a MOST bus (Media Orientated Systems Transport bus), or some other bus configuration; or by a wireless connection.

Control systems in modern vehicles commonly comprise communication bus systems consisting of one or more communication buses for linking a plurality of electronic control units (ECU's), or controllers, and various components located on the vehicle. Such a control system can comprise a large number of control units and/or control arrangements and the responsibility for a specific function can be divided amongst more than one control unit. Vehicles of the shown type thus often comprise significantly more control units or control arrangements than are shown in FIG. 1, which is well known to the person skilled in the art within this technical field. Alternatively, or in addition thereto, the embodiments of the present invention may be implemented wholly or partially in one or more other control units already present in the vehicle.

Here and in this document, units are often described as being provided for performing steps of the method according to embodiments of the invention. This also includes that the units are designed to and/or configured to perform these method steps.

With reference to FIGS. 1 and 4, the units 152, 154, 156 of the control arrangement 150 are in FIG. 1 illustrated as separate units. These units 152, 154, 156 may, however, be logically separated but physically implemented in the same unit, or can be both logically and physically arranged together. These units 152, 154, 156 may for example correspond to groups of instructions, which can be in the form of programming code, that are input into, and are utilized by a processor/computing unit 601 (see FIG. 7) when the units are active and/or are utilized for performing its method step.

With reference to FIG. 7, the control arrangement 150, which may include one or more control units 600, e.g. a device or a control device, according to embodiments of the present invention may be arranged to perform all of the method steps mentioned above, in the claims, and in connection with the herein described embodiments. The control arrangement 150 is associated with the above described advantages for each respective embodiment.

According to the second aspect of the invention, a computer program 603 (see FIG. 7) is provided, comprising instructions which, when the program is executed by a computer, cause the computer to carry out the method according to one or more of the embodiments disclosed above.

According to the third aspect of the invention, a computer-readable medium is provided, comprising instructions which, when the instructions are executed by a computer, cause the computer to carry out the method according to one or more of the embodiments disclosed above.

The person skilled in the art will appreciate that the herein described embodiments of the method according to the first aspect may be implemented in a computer program, which, when it is executed in a computer, instructs the computer to execute the method. The computer program is usually constituted by a computer program product 603 stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

FIG. 8 schematically illustrates an example of an electrical battery unit 700 which can be connected to a vehicle electrical system 108, for example as disclosed above and/or be carried by, or included in, a vehicle 100 or in a powertrain 104 of the vehicle 100, for example as disclosed above. The electrical battery unit 700 may be referred to as one or more electric batteries 700.

With reference to FIG. 8, the electrical battery unit 700 may include one or more electric battery cells 702 which may be arranged in a module. Each electric battery cell 702 can be seen as a container chemically storing energy and may be a rechargeable electric battery cell. The electrical battery cell 702 may for example be a Li-ion battery cell or a NiMH battery cell but are not limited thereto. The electric battery cells 702 may be electrically connected in series and in parallel, into the electric battery unit 700, which may be referred to as an electric battery pack, in order to attain the desired voltage and energy capacity. In shown embodiment, the electric battery cells 702 are electrically connected in series with one another and are part of a main power line 712. The electric battery unit 700 or pack may form the complete enclosure or unit that delivers electric power to a product or equipment, for example an electric vehicle, EV, such as a vehicle 100 illustrated in FIG. 1.

With reference to FIG. 8, the electric battery unit 700 may include a cell controller 706 which is electrically connected in parallel with each electric battery cell 702 by way of a plurality of electrical lines 708, for example electrical wires. The cell controller 706 may be called a cell module controller (CMC). Each electric battery cell 702 may include a cell fuse 710 for short-circuit protection. However, in some arrangements, the cell fuse 710 may be excluded from the electric battery cell 702.

With reference to FIG. 8, In general, the electrical battery unit 700 has two terminals 714, 716 for connecting the electrical battery unit 700 to a vehicle electrical system 108. The two terminals 714, 716 may be disclosed as electrical contacts. One of the two terminals 714, 716 may be a negative terminal having a negative pole, while the other one of the two terminals 714, 716 may be a positive terminal having a positive pole.

The unit 700 illustrated in FIG. 8 may also represent an electric battery module 700 included in an electric battery pack 800 schematically illustrated in FIG. 9. With reference to FIG. 9, the electric battery pack 800 may comprise a plurality of electric battery modules 700 which may be electrically connected in series and have two common outputs 802, 804 (positive and negative) for electric power, or current, transfer. The electric battery pack 800 may have two terminals 814, 816 (DC positive and DC negative) for electric power, or current, transfer, to be connected to a vehicle electrical system 108. The above-mentioned two common outputs 802, 804 are connected to the two terminals 814, 816 of the electric battery pack 800.

With reference to FIG. 9, in general, the electric battery pack 800 (and/or the electric battery unit 700) may comprise one or more internal contactors 806 switchable between an open position and a closed position. When the internal contactor 806 is in the closed position, the internal contactor 806 is configured to conduct an electric current or allow an electric current to pass. When the internal contactor 806 is in the open position, the internal contactor 806 is configured to interrupt an electric current, or an electrical conductivity, such that no electric current can pass through the internal contactor 806. In general, the one or more internal contactors 806 of the electric battery pack 800 (and/or electric batter unit 700) is/are controlled by a battery management system 808, BMS, of the electric battery pack 800. The battery management system 808, BMS, is a control system for controlling the electric battery pack 800 (and/or the electric battery unit 700). The battery management system 808 may be connected to and communicate with the above-mentioned cell module controller, CMC, 706 of the electric battery unit 700. The battery management system 808 may be configured to determine and/or measure the voltage upstream (before) and downstream (after) of the one or more internal contactors 806, for example at voltage measurement points or locations, for example with the aid of one or more sensors. In general, when the battery management system 808 is deactivated, or not turned on, which in general is the case before the electric battery pack 800 (and/or the electric battery unit 700) is electrically connected to an electrical system, for example a vehicle electrical system 108, the internal contactor 806 cannot switch to the closed position.

With reference to FIG. 9, in general, when the battery management system 808 is activated or active, a pre-charging of an electrical system (such as the vehicle electrical system 108, which may referred to as VCB) is essentially always performed before all the internal contactors 806 are closed, for example with the aid of a pre-charge contactor 810 switchable between an open position and a closed position. Pre-charging of a high voltage direct current system is known to the person skilled in the art and is thus not discussed in further detail.

With reference to FIG. 9, in general, the electric battery pack 800 (and/or the electric battery unit 700) comprises an electric battery pack fuse 812, or an electric battery fuse, which, for example, may be a melt fuse, or a pyrotechnic fuse (or pyro fuse), for protection. The pyrotechnic fuse is functional only when the battery management system 808 is active. It is to be understood that the electric battery pack 800 may include additional electrical components or equipment known to the person skilled in the art, such as sensors, but these are left out for illustrative purposes.

The present invention is not limited to the above described embodiments. Instead, the present invention relates to, and encompasses all different embodiments being included within the scope of the independent claims.

1. A method for a procedure of connection and disconnection of a vehicle to/from a plurality of electrical lines of an electric road system, wherein the connection and disconnection procedure comprises, in response to a disconnect warning and if the vehicle is connected to the plurality of electrical lines, blocking the electric current from the plurality of electrical lines to a powertrain of the vehicle, and
wherein the method comprises:
maintaining the connection of the vehicle to the plurality of electrical lines while the electric current from the plurality of electrical lines to the powertrain of the vehicle is blocked in response to the disconnect warning.

2. A method according to claim 1, wherein the blocking of the electric current from the plurality of electrical lines to the powertrain of the vehicle is performed in the vehicle.

3. A method according to claim 1, wherein the blocking of the electric current from the plurality of electrical lines to the powertrain of the vehicle comprises decreasing the electric current from the plurality of electrical lines to the powertrain of the vehicle below a first threshold.

4. A method according to claim 1, wherein the blocking of the electric current from the plurality of electrical lines to the powertrain of the vehicle comprises decreasing the electric current from the plurality of electrical lines to the powertrain of the vehicle to zero.

5. A method according to claim 1, wherein the method further comprises:
when the connection of the vehicle to the plurality of electrical lines is maintained and the disconnect warning is cleared, passing the electric current from the plurality of electrical lines to the powertrain of the vehicle.

6. A method according to claim 5, wherein the passing of the electric current from the plurality of electrical lines to the powertrain of the vehicle comprises increasing the electric current from the plurality of electrical lines to the powertrain of the vehicle above a second threshold.

7. A method according to claim 1, wherein the method further comprises:
when the connection of the vehicle to the plurality of electrical lines is maintained and the disconnect warning is not cleared, disconnecting the vehicle from the plurality of electrical lines while the electric current from the plurality of electrical lines to the powertrain of the vehicle is blocked in response to the disconnect warning.

8. A method according to claim 1, wherein the disconnect warning comprises one or more of the group of:
the vehicle is about to leave a proper path of a road associated with the electric road system;
a voltage associated with the electric current from the plurality of electrical lines to the powertrain of the vehicle falls below a third threshold;
the vehicle is about to leave a first predefined zone associated with the electric road system; and
the vehicle is about to enter a second predefined zone associated with the electric road system.

9. A method according to claim 1, wherein the vehicle comprises an interface for providing connection between the vehicle and the plurality of electrical lines, and
wherein the interface comprises a connection device movable between a connection position, in which the connection device and the vehicle are connected to the plurality of electrical lines, and a disconnection position, in which the connection device and the vehicle are disconnected from the plurality of electrical lines, and
wherein the step of maintaining the connection of the vehicle to the plurality of electrical lines, while the electric current from the plurality of electrical lines to the powertrain of the vehicle is blocked in response to the disconnect warning, comprises maintaining the connection device in the connection position.

10. A method according to claim 1, wherein the vehicle comprises an interface for providing connection between the vehicle and the plurality of electrical lines, and
wherein the interface comprises a DC-to-DC converter, and
wherein the method further comprises controlling the DC-to-DC converter to block and/or pass the electric current from the plurality of electrical lines to the powertrain of the vehicle.

11. A method according to claim 1, wherein the vehicle comprises an interface for providing connection between the vehicle and the plurality of electrical lines,
wherein the interface comprises an electrically operable switching device switchable between an open position and a closed position,
wherein when the switching device is in the closed position the switching device is configured to allow the electric current to pass, and
wherein when the switching device is in the open position the switching device is configured to interrupt the electric current, and
wherein the method further comprises switching the switching device to the open or closed position to block and/or pass the electric current from the plurality of electrical lines of the vehicle.

12. A method according to claim 1, wherein the plurality of electrical lines comprises or consists of a plurality of overhead electrical lines,
wherein the connection and disconnection procedure comprises the connection and disconnection of the vehicle to/from the plurality of overhead electrical lines of an electric road system,
wherein the connection and disconnection procedure comprises in response to a disconnect warning and if the vehicle is connected to the plurality of overhead electrical lines, blocking the electric current from the plurality of overhead electrical lines to a powertrain of the vehicle, and
wherein the method comprises:
maintaining the connection of the vehicle to the plurality of overhead electrical lines while the electric current from the plurality of electrical lines to the powertrain of the vehicle is blocked in response to the disconnect warning.

13. A computer program comprising computer program code stored on a non-transitory computer-readable medium, said computer program product used for a procedure of connection and disconnection of a vehicle to/from a plurality of electrical lines of an electric road system, wherein the connection and disconnection procedure comprises, in response to a disconnect warning and if the vehicle is connected to the plurality of electrical lines, blocking the electric current from the plurality of electrical lines to a powertrain of the vehicle, said computer program code comprising computer instructions to cause one or more control units to perform the following operation:
maintaining the connection of the vehicle to the plurality of electrical lines while the electric current from the plurality of electrical lines to the powertrain of the vehicle is blocked in response to the disconnect warning.

14. (canceled)

15. A control arrangement for a procedure of connection and disconnection of a vehicle to/from a plurality of electrical lines of an electric road system, wherein the connection and disconnection procedure comprises in response to a disconnect warning and if the vehicle is connected to the plurality of electrical lines, blocking the electric current from the plurality of electrical lines to a powertrain of the vehicle,
wherein the control arrangement is configured to:
maintain the connection of the vehicle to the plurality of electrical lines while the electric current from the plurality of electrical lines to the powertrain of the vehicle is blocked in response to the disconnect warning.

16. A vehicle comprising a control arrangement for a procedure of connection and disconnection of a vehicle to/from a plurality of electrical lines of an electric road system, wherein the connection and disconnection procedure comprises in response to a disconnect warning and if the vehicle is connected to the plurality of electrical lines, blocking the electric current from the plurality of electrical lines to a powertrain of the vehicle,
wherein the control arrangement is configured to:
maintain the connection of the vehicle to the plurality of electrical lines while the electric current from the plurality of electrical lines to the powertrain of the vehicle is blocked in response to the disconnect warning.
